(19) United States
(12) Patent Application Publication
(10) Pub. No.: US 2007/0075282 A1
(43) Pub. Date: Apr. 5, 2007

(54) Radiation image storage panel and process for producing the same

(75) Inventors: Takashi Komiyama, Minamiashigara-shi (JP); Masako Murofushi, Kanagawa-ken (JP); Kenji Takahashi, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/540,547

(22) Filed: Oct. 2, 2006

(30) Foreign Application Priority Data
Sep. 30, 2005 (JP) 287347/2005

(51) Int. Cl. G03C 5/16

(52) U.S. Cl. 250/580

(57) ABSTRACT

A radiation image storage panel comprises a layer containing an europium activated cesium bromide stimulable phosphor. The europium activated cesium bromide stimulable phosphor has a structure such that a ratio of a signal intensity, which corresponds to g=1.90 with respect to europium activated cesium bromide and which is taken in an ESR spectrum at a Q-band, to the signal intensity, which corresponds to g=1.88 with respect to europium activated cesium bromide and which is taken in the ESR spectrum at the Q-band, is equal to at least 0.7. The radiation image storage panel is produced with a process, wherein a vapor phase deposited film, which contains pillar-shaped crystals of the europium activated cesium bromide stimulable phosphor, is formed on the base plate in a vacuum atmosphere and is then subjected to heat processing in the vacuum atmosphere.

### BACKGROUND OF THE INVENTION

1. Field of the Invention

This invention relates to a radiation image storage panel for use in a radiation image recording and reproducing system. This invention also relates to a process for producing the radiation image storage panel.

2. Description of the Related Art

Radiation image recording and reproducing systems utilizing stimulable phosphors have widely been used in practice. With the radiation image recording and reproducing systems utilizing the stimulable phosphors, a sheet-shaped radiation image storage panel containing the stimulable phosphor is exposed to radiation carrying radiation image information of an object, e.g. the radiation having passed through the object or the radiation emanating from the object, and the radiation image information of the object is thereby stored on the radiation image storage panel. The radiation image storage panel, on which the radiation image information of the object has been stored, is then exposed to stimulating rays (an electromagnetic wave, such as visible light or infrared light, e.g. a laser beam), which cause the radiation image storage panel to emit light in proportion to the amount of energy stored on the radiation image storage panel during the exposure of the radiation image storage panel to the radiation. The emitted light is photoelectrically read out, and an image signal representing the radiation image information of the object is thereby obtained. The radiation image storage panel, from which the image signal has been read out, is subjected to an operation for erasing radiation energy remaining on the radiation image storage panel. The erased radiation image storage panel is repeatedly used for next radiation image recording operations.

In order for sensitivity of the radiation image storage panel and image quality of an image obtained with the radiation image storage panel to be enhanced, processes for producing a radiation image storage panel, wherein a stimulable phosphor layer is formed with a vapor phase deposition technique, have heretofore been proposed. The vapor phase deposition technique includes a vacuum evaporation technique, a sputtering technique, and the like. For example, with the vacuum evaporation technique, a deposition material, which is constituted of a stimulable phosphor or raw materials for the stimulable phosphor, is heated with a resistance heater or electron beam irradiation and is thus caused to vaporize and fly. The thus vaporized material is deposited on a surface of a base plate, such as a metal sheet. In this manner, the stimulable phosphor layer constituted of pillar-shaped crystals of the stimulable phosphor is formed.

The stimulable phosphor layer having been formed with the vapor phase deposition technique is constituted of the stimulable phosphor alone and does not contain a binder. In the cases of the stimulable phosphor layer having been formed with the vapor phase deposition technique, cracks are present among the pillar-shaped crystals of the stimulable phosphor. Therefore, an efficiency, with which the stimulating rays enter into the stimulable phosphor layer, and the efficiency, with which the light emitted by the stimulable phosphor layer is taken up, are capable of being enhanced. Accordingly, the stimulable phosphor layer having been formed with the vapor phase deposition technique has a high sensitivity. Also, with the stimulable phosphor layer having been formed with the vapor phase deposition technique, scattering of the stimulating rays toward plane directions is capable of being prevented from occurring, and therefore an image having a high image sharpness is capable of being obtained.

A process for forming a layer constituted of an europium activated cesium bromide stimulable phosphor, which stimulable phosphor layer is capable of markedly enhancing the intensity of the light emitted by the stimulable phosphor layer, is proposed in, for example, U.S. Patent Application Publication No. 20030186023. With the proposed process for forming a layer constituted of an europium activated cesium bromide stimulable phosphor, after a vapor phase deposited film constituted of the pillar-shaped crystals of the stimulable phosphor has been formed on a base plate, the vapor phase deposited film is subjected to heat processing at a temperature falling within the range of 50° C., inclusive, to less than 300° C. for a period of time falling within the range of one hour to eight hours and in an inert gas atmosphere, or in an inert gas atmosphere containing a small amount of an oxygen gas or a small amount of a hydrogen gas. A radiation image storage panel having been produced with the process proposed in, for example, U.S. Patent Application Publication No. 20030186023 has the advantages over conventional radiation image storage panels in that the sensitivity is capable of being kept high, and a radiation image having good image quality is capable of being obtained.

The radiation image storage panels, which are capable of being used repeatedly for the radiation image recording operations, are advantageous from the view point of resource protection and economy. However, it has been known that, in cases where the X-ray irradiation is performed repeatedly on the radiation image storage panel for a long period of time, it often occurs that the stimulable phosphor contained in the radiation image storage panel suffers from X-ray induced damage. The X-ray induced damage is the damage of the stimulable phosphor substance itself. Therefore, it is regarded that the X-ray induced damage adversely affects the intensity of the light emitted by the radiation image storage panel and constitutes a factor for lowering of the sensitivity of the radiation image storage panel. Accordingly, if a resistance of the stimulable phosphor to X-ray induced damage is capable of being enhanced, a service life of the radiation image storage panel will be capable of being kept long.

### SUMMARY OF THE INVENTION

The primary object of the present invention is to provide a radiation image storage panel, which has a high resistance to X-ray induced damage and a high sensitivity and with which a radiation image having good image quality is capable of being obtained.

Another object of the present invention is to provide a process for producing the radiation image storage panel.

The present invention provides a radiation image storage panel, comprising a layer containing an europium activated cesium bromide stimulable phosphor, the europium activated cesium bromide stimulable phosphor having a structure such that a ratio of a signal intensity, which corresponds to g=1.90 with respect to europium activated cesium bromide and which is taken in an ESR spectrum at a Q-band, to the signal intensity, which corresponds to g=1.88 with respect to europium activated cesium bromide and which is taken in the ESR spectrum at the Q-band, is equal to at least 0.7.

The present invention also provides a process for producing a radiation image storage panel, in which a layer containing a neuropium activated cesium bromide stimulable phosphor is formed on a base plate with a vapor phase deposition technique, the process comprising the steps of:

i) forming a vapor phase deposited film, which contains pillar-shaped crystals of the europium activated cesium bromide stimulable phosphor, on the base plate in a vacuum atmosphere, and

ii) subjecting the thus formed vapor phase deposited film to heat processing in the vacuum atmosphere.

The process for producing a radiation image storage panel in accordance with the present invention should preferably be modified such that the heat processing is performed at a temperature falling within the range of 50° C., inclusive, to less than 300° C. for a period of time falling within the range of one hour to eight hours.

The radiation image storage panel in accordance with the present invention comprises the layer containing the europium activated cesium bromide stimulable phosphor. The europium activated cesium bromide stimulable phosphor has the structure such that the ratio of the signal intensity, which corresponds to g=1.90 with respect to europium activated cesium bromide and which is taken in the ESR spectrum at the Q-band, to the signal intensity, which corresponds to g=1 .88 with respect to europium activated cesium bromide and which is taken in the ESR spectrum at the Q-band, is equal to at least 0.7. Therefore, the radiation image storage panel in accordance with the present invention has a high resistance to X-ray induced damage. Accordingly, with the radiation image storage panel in accordance with the present invention, the lowering of a sensitivity (PSL) after the radiation image storage panel has been subjected to the X-ray induced damage is capable of being suppressed.

### BRIEF DESCRIPTION OF THE DRAWINGS

FIG. 1 is a graph showing ESR spectrums of a stimulable phosphor sample prepared in Example 1, a stimulable phosphor sample prepared in Example 2, and a stimulable phosphor sample prepared in Comparative Example 1, and

FIG. 2 is an enlarged graph showing the ESR spectrums of FIG. 1.

### DESCRIPTION OF THE PREFERRED EMBODIMENTS

The present invention will hereinbelow be described in further detail with reference to the accompanying drawings.

The radiation image storage panel in accordance with the present invention is capable of being produced with the process for producing a radiation image storage panel, in which the layer containing the europium activated cesium bromide stimulable phosphor is formed on the base plate with the vapor phase deposition technique, the process comprising the steps of: (i) forming the vapor phase deposited film, which contains the pillar-shaped crystals of the europium activated cesium bromide stimulable phosphor, on the base plate in the vacuum atmosphere, and (ii) subjecting the thus formed vapor phase deposited film to the heat processing in the vacuum atmosphere.

The present invention will hereinbelow be described by taking the europium activated cesium bromide stimulable phosphor, which has a basic composition represented by Formula (I) shown below, as an example.
CsBr·aM^{I}X·bM^{II}X′₂·cM^{III}X″₃:zEu (I)
wherein M^{I} represents at least one kind of alkali metal selected from the group consisting of Li, Na, K, Rb, and Cs; M^{II} represents at least one kind of alkaline earth metal or bivalent metal selected from the group consisting of Be, Mg, Ca, Sr, Ba, Ni, Cu, Zn, and Cd; M^{III} represents at least one kind of rare earth element or trivalent metal selected from the group consisting of Sc, Y, La, Ce, Pr, Nd, Pm, Sm, Eu, Gd, Tb, Dy, Ho, Er, Tm, Yb, Lu, Al, Ga, and In; each of X, X′, and X″ represents at least one kind of halogen selected from the group consisting of F, Cl, Br, and I; a represents a number falling within the range of 0≦a<0.5; b represents a number falling within the range of 0≦b<0.5; c represents a number falling within the range of 0>c<0.5; and z represents a number falling within the range of 0<z<1.0.

The aforesaid definitions of the symbols utilized in Formula (I) will be omitted hereinbelow.

In the process for producing a radiation image storage panel in accordance with the present invention, a deposition material, which contains the stimulable phosphor or a mixture of raw materials for the stimulable phosphor, should preferably contain the Eu constituent in a proportion falling within the range of 1×10⁻⁴ mol to 1×10⁻² mol per mol of the CsBr constituent. Also, a deposition material, which contains the europium activator constituent, should preferably contain EuXₘ, where m represents a number falling within the range of 2.0<m<3.0, and/or EuOX. Further, the vacuum evaporation should preferably be performed with a resistance heating technique. Furthermore, in Formula (I) shown above, M^{I} should preferably represent Cs, and X should preferably represent Br.

The process for producing a radiation image storage panel in accordance with the present invention will hereinbelow be described in detail by taking the cases of the vacuum evaporation processing with the resistance heating technique as an example. The resistance heating technique has the advantages in that the vacuum evaporation processing is capable of being performed at a medium degree of vacuum, and in that a vacuum deposited film constituted of good quality of pillar-shaped crystals is capable of being obtained easily.

Ordinarily, the base plate for the formation of the vacuum deposited film acts also as a support of the radiation image storage panel. The material constituting the base plate may be selected arbitrarily from various materials known as the materials of the supports of the conventional radiation image storage panels. Examples of preferable base plates include a quartz glass sheet; a sapphire glass sheet; a metal sheet constituted of aluminum, iron, tin, chrome, or the like; and a resin sheet constituted of an aramid, or the like. It has been known for the conventional radiation image storage panels that, in order for the sensitivity of the radiation image storage panel or the image quality (such as the image sharpness and graininess characteristics) of the image obtained with the radiation image storage panel to be enhanced, the radiation image storage panel may be provided with a light reflecting layer, which is constituted of a light reflective substance, such as titanium dioxide, or a light absorbing layer, which is constituted of a light absorptive substance, such as carbon black. As for the base plate utilized in the radiation image storage panel in accordance with the present invention, the base plate may be provided with various kinds of layers, such as the light reflecting layer and the light absorbing layer. Constitutions of the aforesaid various kinds of layers may be selected arbitrarily in accordance with purposes, use applications, and the like, of the desired radiation image storage panel. Also, such that the pillar-shaped crystalline characteristics of the vacuum deposited film may be enhanced, fine recesses and protrusions may be formed on the surface of the base plate, on which surface the vacuum deposited film is to be formed. (In cases where an auxiliary layer, such as a prime-coating layer (an adhesion imparting layer), the light reflecting layer, or the light absorbing layer, is formed on the surface of the base plate, the fine recesses and protrusions may be formed on the surface of the auxiliary layer.)

In the process for producing a radiation image storage panel in accordance with the present invention, firstly, as the deposition materials, at least two pieces of deposition materials, i.e. the deposition material containing the stimulable phosphor and the deposition material containing the activator Eu constituent, are prepared. The deposition material containing the stimulable phosphor may be the stimulable phosphor itself. Alternatively, the deposition material containing the stimulable phosphor may be a mixture of raw materials for the stimulable phosphor. For example, the deposition material containing the stimulable phosphor may be the mixture of the nucleus CsBr constituent of the stimulable phosphor and the activator Eu constituent. Alternatively, the deposition material containing the stimulable phosphor may be the mixture of the nucleus CsBr constituent of the stimulable phosphor, the activator Eu constituent, and additive constituents. As another alternative, the deposition material containing the stimulable phosphor may be the mixture of the stimulable phosphor and the activator Eu constituent. The nucleus CsBr constituent may be the CsBr compound itself. Alternatively, the nucleus CsBr constituent may be the mixture of at lest two kinds of raw materials, which are capable of yielding the CsBr compound through a reaction. Ordinarily, the activator Eu constituent is a compound containing Eu. For example, a halide of Eu or an oxide of Eu is employed as the activator Eu constituent. The Eu constituent should preferably be contained in a proportion falling within the range of 1×10⁻⁴ mol to 1×10⁻² mol per mol of the CsBr constituent.

Ordinarily, the deposition material containing the activator Eu constituent is an Eu compound. For example, a halide of Eu or an oxide of Eu is employed as the deposition material containing the activator Eu constituent. The deposition material containing the activator Eu constituent should preferably be EuX′″ₘ, EuOX′″, or a mixture of EuX′″ₘ and EuOX′″, wherein m represents a number falling within the range of 2.0<m<3, and X′″ represents F, Cl, Br, and/or I. The halogen X′″ should preferably be identical with X of the nucleus M^{I}X constituent described above, and should more preferably be Br.

Ordinarily, the Eu compound contains Eu²⁺ and Eu³⁺ mixed together. The desired light emission (or the desired instantaneous light emission) occurs from the stimulable phosphor containing Eu²⁺ as the activator. Therefore, EuX′″ₘ should preferably have a composition such that the molar ratio of Eu²⁺ is equal to at least 70%. Specifically, in the formula EuX′″ₘ, m should preferably represents a number falling within the range of 2.0<m<2.3. It is desirable that m is set at a number of 2.0. However, in cases where m is set at a number close to 2.0, oxygen is apt to mix in the EuX′″ₘ compound. Accordingly, actually, the EuX′″ₘ compound is capable of being kept stable in the state, in which m is set at a number in the vicinity of 2.2, and in which the proportion of the halogen X′″ is comparatively high.

The number of the deposition materials is not limited to two. For example, the aforesaid two pieces of the deposition materials and a deposition material constituted of additive constituents, and the like, may be utilized.

A moisture content of each of the deposition materials should preferably be at most 0.5% by weight. In cases where the nucleus constituent of the stimulable phosphor has hygroscopic characteristics as in the cases of, for example, CsBr, the stimulable phosphor is apt to contain moisture. From the view point of prevention of bumping, or the like, it is important that the moisture content of the deposition material is suppressed at the low value as described above. Dehydration of the deposition material should preferably be performed with a technique, in which the aforesaid stimulable phosphor constituent is subjected to heat processing under reduced pressure and at a temperature falling within the range of 100° C. to 300° C. Alternatively, the stimulable phosphor constituent may be hot melted in an atmosphere, which does not contain moisture, such as a nitrogen gas atmosphere, at a temperature equal to at least the melting temperature of the stimulable phosphor constituent and for a period ranging from several tens of minutes to several hours.

Also, each of the deposition materials, in particular the deposition materials containing the stimulable phosphor, should preferably be constituted such that the content of alkali metal impurities (i.e., the alkali metals other than the constituent elements of the stimulable phosphor) may be equal to at most 10 ppm, and such that the content of alkaline earth metal impurities (i.e., the alkaline earth metals other than the constituent elements of the stimulable phosphor) may be equal to at most 5 ppm (by weight). In order for each of the deposition materials constituted in the manner described above to be prepared, the raw materials, in which the content of the alkali metal impurities and the content of the alkaline earth metal impurities are small, may be utilized.

The plurality of the deposition materials and the base plate are located within a vacuum evaporation apparatus, and the region within the vacuum evaporation apparatus is evacuated to a medium degree of vacuum falling within the range of approximately 0.05 Pa to approximately 10 Pa. Alternatively, the region within the vacuum evaporation apparatus may be evacuated to a high degree of vacuum falling within the range of approximately 1×10⁻⁵Pa to approximately 1×10⁻² Pa and may then be set at the aforesaid medium degree of vacuum by the introduction of an inert gas, such as an Ar gas, an Ne gas, or an N₂ gas, into the vacuum evaporation apparatus.

In order for good pillar-shaped crystalline characteristics to be obtained, the base plate should preferably be heated to a temperature falling within the range of 50° C. to 300° C. by the utilization of a heater, or the like, from the rear surface of the base plate. The base plate should more preferably be heated to a temperature falling within the range of 100° C. to 290° C. in the same manner as that described above.

Thereafter, an electric current is applied across each of resistance heaters for the deposition materials in the vacuum evaporation apparatus, and each of the deposition materials is thereby heated. The stimulable phosphor, the activator constituent, and the like, which are contained in the deposition materials, are thus caused to vaporize and fly. As a result, the stimulable phosphor, the activator constituent, and the like, undergo a reaction and form the desired stimulable phosphor. The thus formed stimulable phosphor is deposited on the surface of the base plate. At this time, the distance between each of the deposition materials and the base plate may vary in accordance with the size of the base plate, or the like. Ordinarily, the distance between each of the deposition materials and the base plate may fall within the range of 10 mm to 1,000 mm. Also, ordinarily, the distance between the adjacent deposition materials may fall within the range of 10 mm to 1,000 mm. The deposition rate of each of the deposition materials is capable of being controlled through the adjustment of the resistance current of the corresponding resistance heater, or the like. Also, during the vacuum evaporation processing, the deposition rate of the deposition material containing the activator constituent may be altered. Alternatively, the vacuum deposition of the deposition material containing the activator constituent may be ceased midway during the vacuum evaporation processing. Ordinarily, the deposition rate of the stimulable phosphor, i.e. the rate at which the stimulable phosphor is deposited on the base plate, may fall within the range of 0.1 μm/minute to 1,000 μm/minute, and should preferably fall within the range of 1 μm/minute to 100 μm/minute.

It is also possible to perform the processing, in which the heating operation with each of the resistance heaters is performed a plurality of times, and in which at least two stimulable phosphor layers are thereby formed on the base plate.

Before the vacuum deposited film constituted of the desired stimulable phosphor is formed on the base plate, a vacuum deposited film constituted of only the nucleus (M^{I}X) of the stimulable phosphor may be formed on the base plate. In such cases, the pillar-shaped crystals of the stimulable phosphor are capable of being grown on the pillar-shaped crystals of the nucleus, which have good shapes, in one-to-one relationship with the pillar-shaped crystals of the nucleus. Therefore, in such cases, the vacuum deposited film having the pillar-shaped crystalline characteristics having been enhanced even further is capable of being obtained. The additives, such as the activator, in the vacuum deposited film, which is constituted of the stimulable phosphor, diffuse in the vacuum deposited film, which is constituted of the stimulable phosphor nucleus, due to the heating of the base plate at the time of the vacuum evaporation processing and/or due to the heat processing performed after the vacuum evaporation processing. Therefore, the boundary between the additives and the stimulable phosphor nucleus is not necessarily definite.

After the vacuum evaporation processing has been performed, the vacuum deposited film having been obtained is subjected directly to the heat processing within the vacuum evaporation apparatus, which is being kept at the medium degree of vacuum falling within the range of approximately 0.05 Pa to approximately 10 Pa. The heat processing should preferably be performed at a temperature falling within the range of 50° C., inclusive, to less than 300° C. for a period of time falling within the range of one hour to eight hours.

In the manner described above, the stimulable phosphor layer, in which the pillar-shaped crystals of the stimulable phosphor have grown approximately in the thickness direction of the stimulable phosphor layer, is obtained. The thus obtained stimulable phosphor layer is constituted of the stimulable phosphor alone and does not contain a binder. Also, in the stimulable phosphor layer, the cracks are present among the pillar-shaped crystals of the stimulable phosphor. The layer thickness of the stimulable phosphor layer may vary in accordance with the characteristics required of the radiation image storage panel, the means for performing the vacuum evaporation processing, the conditions under which the vacuum evaporation processing is performed, and the like. The layer thickness of the stimulable phosphor layer may ordinarily fall within the range of 50 μm to 1 mm, and should preferably fall within the range of 200 μm to 700 μm.

The technique for the vacuum evaporation processing employed in the present invention is not limited to the resistance heating technique and may be, for example, an electron beam irradiation technique. In cases where the electron beam irradiation technique is employed for the vacuum evaporation processing, the vacuum evaporation processing may be performed in the manner described below. Specifically, the region within the vacuum evaporation apparatus is evacuated to a degree of vacuum falling within the range of approximately 1×10⁻⁵ Pa to approximately 1×10⁻² Pa. Also, an acceleration voltage is set at a value falling within the range of 1.5 kV to 5.0 kV. Electron beams are thus produced by a plurality of electron guns and irradiated to the corresponding deposition materials.

The base plate need not necessarily act also as the support of the radiation image storage panel. Specifically, after the stimulable phosphor layer has been formed on the base plate, the stimulable phosphor layer may be separated from the base plate and bonded to a support, which has been prepared previously, by use of, for example, an adhesive agent. The stimulable phosphor may thus be over laid on the support. Alternatively, the stimulable phosphor layer may not be provided with the support (or the base plate).

For convenience in conveyance and processing of the radiation image storage panel and for prevention of a change in characteristics of the radiation image storage panel, a protective layer should preferably be formed on the surface of the stimulable phosphor layer. The protective layer should preferably be transparent, such that the protective layer may not affect the incidence of the stimulating rays upon the stimulable phosphor layer and the radiating of the light emitted by the stimulable phosphor layer. Also, such that the radiation image storage panel may be protected sufficiently from physical impacts and chemical attacks given from the exterior, the protective layer should preferably be chemically stable and should preferably have a high moisture resistance and a high physical strength.

The protective layer may be formed with a technique, in which a solution containing a transparent organic polymer substance, such as a cellulose derivative, a polymethyl methacrylate, or a fluorine type resin soluble in an organic solvent, dissolved in an appropriate solvent is applied on to the stimulable phosphor layer. Alternatively, the protective layer may be formed with a technique, in which a sheet for the formation of the protective layer, such as an organic polymer film of, e.g., a polyethylene terephthalate, or a transparent glass plate, is formed previously and overlaid on the surface of the stimulable phosphor layer by use of an appropriate adhesive agent. As another alternative, the protective layer may be formed with a technique, in which a film of an inorganic compound is formed on the stimulable phosphor layer by use of the vacuum evaporation processing, or the like. Also, the protective layer may contain various additives in a dispersed form. Examples of the additives, which maybe contained in the protective layer, include light-scattering fine particles, such as fine particles of magnesium oxide, zinc oxide, titanium dioxide, or alumina; a lubricant, such as perfluoro olefin resin powder, or silicone resin powder; and a crosslinking agent, such as a polyisocyanate. In cases where the protective layer is constituted of the polymer substance, ordinarily, the layer thickness of the protective layer may fall within the range of approximately 0.1 μm to approximately 20 μm. In cases where the protective layer is constituted of the inorganic compound, such as glass, ordinarily, the layer thickness of the protective layer may fall within the range of approximately 100 μm to approximately 1,000 μm.

In order for the stain resistance of the protective layer to be enhanced, a fluorine resin coating layer may be formed on the surface of the protective layer. The fluorine resin coating layer maybe formed with a technique, in which a fluorine resin coating composition containing a fluorine resin dissolved (or dispersed) in an organic solvent is applied onto the surface of the protective layer, and in which the applied layer of the fluorine resin coating composition is dried. The fluorine resin may be used alone. However, ordinarily, the fluorine resin is used as a mixture of the fluorine resin and a resin having good film forming characteristics. Alternatively, the fluorine resin may be used together with an oligomer having a polysiloxane skeleton or an oligomer having a perfluoro alkyl group. Such that interference nonuniformity may be suppressed, and such that the image quality of the obtained radiation image may be enhanced, the fluorine resin coating layer may also contain a fine particle filler. Ordinarily, the layer thickness of the fluorine resin coating layer may fall within the range of 0.5 μm to 20 μm. For the formation of the fluorine resin coating layer, additive constituents, such as a crosslinking agent, a hardener, and an anti-yellowing agent, may also be utilized. In particular, the addition of the crosslinking agent is advantageous for the enhancement of the durability of the fluorine resin coating layer.

The radiation image storage panel in accordance with the present invention is capable of being obtained in the manner described above. The constitution of the radiation image storage panel in accordance with the present invention may be modified in various known ways. For example, such that the image sharpness of the obtained image may be enhanced, at least one of the layers described above may be colored with a coloring agent, which is capable of absorbing the stimulating rays and does not absorb the light emitted by the stimulable phosphor layer.

The signal, which corresponds to g=1.90 with respect to europium activated cesium bromide and which is taken in the ESR spectrum at the Q-band, and the signal, which corresponds to g=1.88 with respect to europium activated cesium bromide and which is taken in the ESR spectrum at the Q-band, originate respectively from two kinds of structures varying in symmetry (zero-field splitting constant) around Eu²⁺ in the stimulable phosphor layer. In accordance with an XAFS method, it is presumed that the difference between the two kinds of the structures described above is the difference in Eu²⁺ neighboring oxygen quantity, and that the structure, from which the signal corresponding to g=1.90 originates, has the Eu²⁺ neighboring oxygen quantity smaller than the Eu²⁺ neighboring oxygen quantity of the structure, from which the signal corresponding to g=1.88 originates. The X-ray induced damage process is an oxidation reaction, in which Eu²⁺ is converted into Eu³⁺. Therefore, it is considered that the structure, from which the signal corresponding to g=1.90 originates and which has the comparatively small Eu²⁺ neighboring oxygen quantity, has a comparatively high resistance to X-ray induced damage. Accordingly, it is considered that the stimulable phosphor, which contains a comparatively large quantity of Eu²⁺ having the structure corresponding to g=1.90, is preferable from the view point of the resistance to X-ray induced damage. In cases where a new signal arises due to the mixing of a different compound in the stimulable phosphor layer, or in cases where the magnetic field shifts, a correction may be made, and the ratio of the signal intensity, which corresponds to g=1.90 with respect to europium activated cesium bromide and which is taken in the ESR spectrum at the Q-band, to the signal intensity, which corresponds to g=1. 88 with respect to europium activated cesium bromide and which is taken in the ESR spectrum at the Q-band, may thereby be calculated.

The present invention will further be illustrated by the following non-limitative examples.

### EXAMPLES

### Example 1

A 1 mm-thick aluminum base plate was prepared as a base plate for vacuum evaporation processing. Before the vacuum evaporation processing was performed, the base plate was subjected to plasma cleaning under conditions of 1 Pa, 300 W, and 600 seconds, and organic substances were removed from the surface of the base plate. Thereafter, the base plate was set on a holder in a vacuum chamber of a vacuum evaporation apparatus. Also, as deposition materials, 500 g of CsBr and 10 g of EuBr₂ were filled respectively in crucible vessels for resistance heating, which crucible vessels were located within the vacuum evaporation apparatus. The distance between the base plate and each of the deposition materials was set at 100 mm. Further, a shutter was set between the base plate and the crucibles, and the vacuum chamber was closed. Evacuation means was then actuated to evacuate the region within the vacuum chamber. At the time at which the degree of vacuum within the vacuum chamber became equal to 8×10⁻⁴ Pa, an Ar gas was introduced into the vacuum chamber, while the evacuation was being continued, and the pressure within the vacuum chamber was thereby adjusted at 0.75 Pa. Thereafter, the base plate was heated to a temperature of 200° C. by use of a sheathed heater, which was located on the side of the base plate opposite to the vacuum deposition surface of the base plate. Also, electric power sources for the resistance heating were actuated to apply electric power with respect to all of the crucibles, and the deposition materials were thus heated. When a period of time of 60 minutes had elapsed after the beginning of the heating of the deposition materials, the shutter was opened, linear conveyance of the base plate was begun, and the formation of a stimulable phosphor layer on the base plate was thereby started. The deposition rate was adjusted at 10 μm/minute. Also, the vacuum evaporation processing was controlled such that the Eu/Cs molar ratio in the stimulable phosphor layer might become equal to 0.001/1.

After the vacuum evaporation processing was completed, the shutter was closed, and the vacuum deposited film having been formed on the aluminum base plate in the manner described above was subjected to heat processing within the vacuum evaporation apparatus at a temperature of 200° C. for one hour, while the degree of vacuum of 0.75 Pa was being kept. Thereafter, electric power sources for the resistance heating were turned off, and the introduction of the Ar gas was ceased. Dry air was then introduced into the chamber, and the pressure within the chamber was thereby set at the atmospheric pressure. Thereafter, the aluminum base plate, on which the vacuum deposited film had been formed, was taken out from the chamber.

It was found that the vacuum deposited film (film thickness: approximately 600 μm, area: 19cm×19cm) having a structure, in which pillar-shaped crystals of the stimulable phosphor stood close to one another and extended in directions approximately normal to the surface of the base plate, had been formed on the aluminum base plate. Observation and measurement of the vacuum deposited film by use of a scanning electron microscope (Model JSM-5400, supplied by Nippon Denshi K. K.) revealed that the mean diameter of the pillar-shaped crystals was equal to approximately 3 μm, the mean height of the pillar-shaped crystals was equal to approximately 600 μm, and the mean aspect ratio was equal to approximately 200.

### Example 2

After the procedure in Example 1 had been performed, the aluminum base plate, on which the vacuum deposited film had been formed, was located in a vacuum heating apparatus, into which a gas was capable of being introduced. The vacuum heating apparatus was then evacuated to a vacuum of approximately 1 Pa by use of a rotary pump, and moisture, or the like, having been adhered to the vacuum deposited film was thereby removed from the vacuum deposited film. Thereafter, the vacuum deposited film was subjected to heat processing at a temperature of 200° C. For one hour in a nitrogen gas atmosphere and was then taken out of the vacuum heating apparatus.

### Comparative Example 1

After the vacuum evaporation processing was completed in the same manner as that in Example 1, the shutter was closed, the electric power sources for the resistance heating were turned off, and the introduction of the Ar gas was ceased. Dry air was then introduced into the chamber, and the pressure within the chamber was thereby set at the atmospheric pressure. Thereafter, the aluminum base plate, on which the vacuum deposited film had been formed, was taken out from the chamber. Thereafter, the aluminum base plate, on which the vacuum deposited film had been formed, was located in the vacuum heating apparatus, into which a gas was capable of being introduced. The vacuum heating apparatus was then evacuated to a vacuum of approximately 1 Pa by use of the rotary pump, and moisture, or the like, having been adhered to the vacuum deposited film was thereby removed from the vacuum deposited film. Thereafter, the vacuum deposited film was subjected to heat processing at a temperature of 200° C. For one hour in a nitrogen gas atmosphere and was then taken out of the vacuum heating apparatus. Observation and measurement of the vacuum deposited film by use of the scanning electron microscope (Model JSM-5400, supplied by Nippon Denshi K. K.) revealed that the mean diameter of the pillar-shaped crystals was equal to approximately 3 μm, the mean height of the pillar-shaped crystals was equal to approximately 600 μm, and the mean aspect ratio was equal to approximately 200.

(Evaluation of Resistance to X-Ray Induced Damage)

Each of the radiation image storage panels having been produced in Examples 1 and 2 and Comparative Example 1 was accommodated within a cassette capable of blocking ambient indoor light, and 10 mR X-rays at a tube voltage of 80 kVp were irradiated to the radiation image storage panel having been accommodated within the cassette. Thereafter, the radiation image storage panel was taken out from the cassette, and a laser beam (wavelength: 633 nm) was irradiated to the surface of the radiation image storage panel. The light, which was emitted by the radiation image storage panel when the laser beam was irradiated to the surface of the radiation image storage panel, was detected with a photo multiplier, and an initial light emission quantity (i.e., an initial PSL) was measured.

The light emission quantity (PSL), which had been measured with the method identical with the aforesaid method of measuring the PSL, was taken as the initial PSL. Also, the light emission quantity, which was obtained after the irradiation of 50 mR X-rays at a tube voltage of 80 kVp to the radiation image storage panel and the erasing of the radiation image storage panel with a white fluorescent lamp has been iterated 50,000 times, was taken as a post-irradiation PSL. The resistance to X-ray induced damage was evaluated with the ratio of the post-irradiation PSL to the initial PSL (post-irradiation PSL/initial PSL: in %).

(Measurement of ESR)

Each of the stimulable phosphor samples, which had been prepared in Examples 1 and 2 and Comparative Example 1, was put into a synthetic quartz tube for ESR in the ambient atmosphere and sealed in the synthetic quartz tube. The stimulable phosphor sample having thus been sealed in the synthetic quartz tube was subjected to ESR measurement at 10K. Conditions for the ESR measurement were set as shown below.
Measuring apparatus: Electron spin resonance apparatus (EMX, supplied by Bruker Co.)
Electromagnetic wave band: Q-band (34,000 MHz)
Magnetic field scanning range: 10,000±5,000 G
Magnetic field modulation width: 4 G
Magnetic field modulation frequency: 100 kHz
Number of times of integration: Four times
Micro-wave output power: 0.25 mW

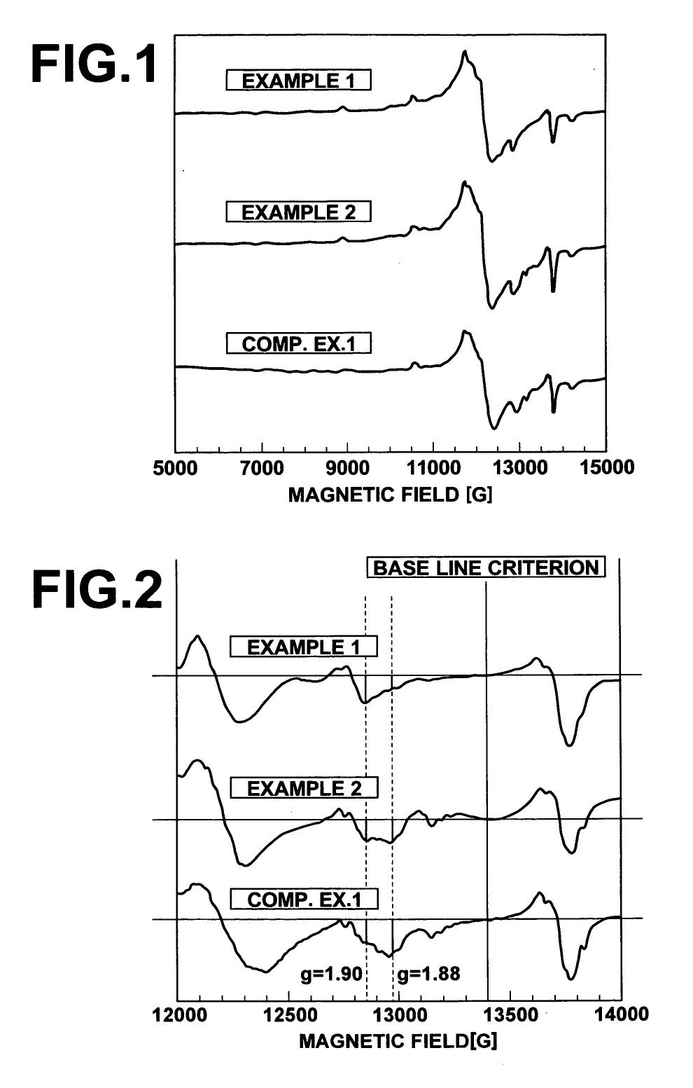

FIG. 1 shows ESR spectrums of the stimulable phosphor samples having been prepared in Examples 1 and 2 and Comparative Example 1. FIG. 2 is an enlarged graph showing spectrum ranges of 12,000 G to 14,000 G in the ESR spectrums of FIG. 1. Each of the spectrums illustrated in FIG. 2 was obtained with an operation, in which an agglomerate-originating broad signal (g≈2.005, ΔHpp=700 G) was subtracted from the corresponding ESR spectrum illustrated in FIG. 1 by use of linear analysis software (SimFonia, supplied by Bruker Co.). Also, a base line was set at a magnetic field of 13,400 G in the enlarged spectrums shown in FIG. 2, and the signal intensity corresponding to the base line in each of the enlarged spectrums shown in FIG. 2 was taken as a zero point of the signal intensity. Further, with respect to each of the enlarged spectrums shown in FIG. 2, the signal intensity was read out downwardly from the zero point (i.e., the bold line part extending from the zero point downwardly along the vertical axis of the graph of FIG. 2 was read out), and the signal intensity ratio of g=1.90/g=1.88 was calculated. The results shown in Table 1 below were obtained.

TABLE 1

| | Resistance to | Signal intensity |
|---|---|---|
| | X-ray induced | ratio of g = 1.90/ |
| | damage (%) | g = 1.88 in ESR spectrum |
| Example 1 | 100 | 2.17 |
| Example 2 | 90 | 0.916 |
| Comparative | 70 | 0.578 |
| Example 1 | | |

As described above, the signal, which corresponds to g=1.90 with respect to europium activated cesium bromide and which is taken in the ESR spectrum at the Q-band, and the signal, which corresponds to g=1.88 with respect to europium activated cesium bromide and which is taken in the ESR spectrum at the Q-band, originate respectively from two kinds of structures varying in symmetry (zero-field splitting constant) around Eu²⁺ in the stimulable phosphor layer. In accordance with the XAFS method, it is presumed that the difference between the two kinds of the structures described above is the difference in Eu²⁺ neighboring oxygen quantity, and that the structure, from which the signal corresponding to g=1.90 originates, has the Eu²⁺ neighboring oxygen quantity smaller than the Eu²⁺ neighboring oxygen quantity of the structure, from which the signal corresponding to g=1.88 originates. The X-ray induced damage process is an oxidation reaction, in which Eu²⁺ is converted into Eu³⁺. Therefore, it is considered that the structure, from which the signal corresponding to g=1.90 originates and which has the comparatively small Eu²⁺ neighboring oxygen quantity, has a comparatively high resistance to X-ray induced damage. Accordingly, it is considered that the stimulable phosphor, which contains a comparatively large quantity of Eu²⁺ having the structure corresponding to g=1.90, is preferable from the view point of the resistance to X-ray induced damage.

As clear from Table 1, each of the radiation image storage panels having been produced in Examples 1 and 2, wherein the ratio of the signal intensity, which corresponded to g=1.90 with respect to europium activated cesium bromide and which was taken in the ESR spectrum at the Q-band, to the signal intensity, which corresponded to g=1.88 with respect to europium activated cesium bromide and which was taken in the ESR spectrum at the Q-band, was equal to at least 0.7, had a higher resistance to X-ray induced damage than the resistance to X-ray induced damage of the radiation image storage panel having been produced in Comparative Example 1, in which the aforesaid signal intensity ratio was less than 0.7. Accordingly, with each of the radiation image storage panels having been produced in Examples 1 and 2, the lowering of the sensitivity (PSL) after the radiation image storage panel had been subjected to the X-ray induced damage was capable of being suppressed. In Example 2, the vacuum heat processing was performed, and thereafter the ordinary heat processing was performed. In such cases, the initial sensitivity was capable of being enhanced.

As described above, the radiation image storage panel in accordance with the present invention comprises the layer containing the europium activated cesium bromide stimulable phosphor. The europium activated cesium bromide stimulable phosphor has the structure such that the ratio of the signal intensity, which corresponds to g=1.90 with respect to europium activated cesium bromide and which is taken in the ESR spectrum at the Q-band, to the signal intensity, which corresponds to g=1.88 with respect to europium activated cesium bromide and which is taken in the ESR spectrum at the Q-band, is equal to at least 0.7. Therefore, the radiation image storage panel in accordance with the present invention has a high resistance to X-ray induced damage. Accordingly, with the radiation image storage panel in accordance with the present invention, the lowering of the sensitivity (PSL) after the radiation image storage panel has been subjected to the X-ray induced damage is capable of being suppressed.

What is claimed is:

1. A radiation image storage panel, comprising a layer containing an europium activated cesium bromide stimulable phosphor,
the europium activated cesium bromide stimulable phosphor having a structure such that a ratio of a signal intensity, which corresponds to g=1.90 with respect to europium activated cesium bromide and which is taken in an ESR spectrum at a Q-band, to the signal intensity, which corresponds to g=1.88 with respect to europium activated cesium bromide and which is taken in the ESR spectrum at the Q-band, is equal to at least 0.7.

2. A process for producing a radiation image storage panel, in which a layer containing an europium activated cesium bromide stimulable phosphor is formed on a base plate with a vapor phase deposition technique, the process comprising the steps of:
i) forming a vapor phase deposited film, which contains pillar-shaped crystals of the europium activated cesium bromide stimulable phosphor, on the base plate in a vacuum atmosphere, and
ii) subjecting the thus formed vapor phase deposited film to heat processing in the vacuum atmosphere.

3. A process as defined in Claim2 wherein the heat processing is performed at a temperature falling within the range of 50° C., inclusive, to less than 300° C. For a period of time falling within the range of one hour to eight hours.
